(19) United States
(12) Patent Application Publication
(10) Pub. No.: US 2026/0226368 A1
(43) Pub. Date: Aug. 6, 2026

(54) SOFT SURFACE CLEANING COMPOSITIONS

(71) Applicant: RECKITT BENCKISER LLC, Parsippany, NJ (US)

(72) Inventors: Heidi FUENTES, Montvale, NJ (US); Rachel JOSEF, Montvale, NJ (US); Jonathan NUNEZ, Montvale, NJ (US); Spencer PINTO, Montvale, NJ (US); Shauna-Kaye SCOTLAND, Montvale, NJ (US); Bikramjit SINGH, Montvale, NJ (US); Lisa YOUNG, Montvale, NJ (US)

(21) Appl. No.: 19/151,136

(22) PCT Filed: Jan. 29, 2024
(86) PCT No.: PCT/EP2024/052081

§ 371 Date: Jul. 25, 2025

(30) Foreign Application Priority Data
Feb. 2, 2023 (GB) 2301526.6

(51) Int. Cl. C11D 1/831; C11D 1/14; C11D 1/29; C11D 1/72; C11D 3/12; C11D 3/18; C11D 3/20; C11D 3/32; C11D 3/37; C11D 3/43; C11D 17/00

(52) U.S. Cl. CPC C11D 1/831; C11D 3/1233; C11D 3/188; C11D 3/2068; C11D 3/32; C11D 3/3723; C11D 3/3765; C11D 3/43; C11D 17/0017; C11D 1/146; C11D 1/29; C11D 1/72

(57) ABSTRACT

Soft surface cleaning compositions are disclosed that clean oxidizable stains without the use of peroxide or bleaching ingredients. The compositions utilize surfactants, solvents, and polymers to clean oxidizable stains as well as or better than peroxide or bleaching agents. The compositions also exhibit anti-soil redeposition properties due to the unique polymer content.

### TECHNICAL FIELD

Soft surface cleaning compositions are disclosed that clean oxidizable stains without the use of peroxide or bleaching ingredients. The compositions utilize surfactants, solvents, and polymers to clean oxidizable stains as well as or better than peroxide or bleaching agents. The compositions also exhibit anti-soil redeposition properties due to the unique polymer content.

### BACKGROUND

Although not interchangeable, hard and soft surface cleaning compositions are known in the art.

US Pat App Pub No 2015/252310 to Ecolab discloses hard surface cleaning compositions including alkyl amide solvent derived from renewable bio-based resources that work at least as well as d-limonene.

US Pat App Pub No 2015/0098745 to Stepan Co discloses aqueous hard surface cleaners based on terpenes and fatty acid derivatives.

US Pat App Pub No 2015/0275144 to The Procter & Gamble Company discloses cleaning compositions containing a polyetheramine that is suitable for removal of stains from soiled materials.

US Pat App Pub No 2018/0105768 to The Clorox Company discloses treatment compositions for use in laundry capable of effectively removing stains better than detergent alone, and which can be used both through the wash and as a pre-treatment.

Bleaches and peroxides are known for their ability to remove oxidizable stains, as well as for stability problems.

A need remains for soft surface cleaning compositions that do not contain bleaches or peroxides but that remove oxidizable stains equally as well as, if not better than, formulations containing bleaches or peroxides.

### BRIEF SUMMARY

Cleaning compositions comprising surfactants, solvents, and polymers are disclosed. The cleaning compositions are substantially free of peroxide or bleaching ingredients. The disclosed cleaning compositions may comprise one or more of the following aspects:
approximately 0.5% w/w to approximately 5% w/w anionic surfactant; (b) approximately 0.05% w/w to approximately 15% w/w of a nonionic alcohol alkoxylate surfactant; (c) approximately 0.5% w/w to approximately 10% w/w of a copolymer having a monomer having the structure:

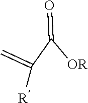

wherein R=an alkali metal, H, vinyl, a C1-C4 alkyl group, or combinations thereof, and R′=H, a C1-C4 alkyl group, or combinations thereof; (d) approximately 0.5% to approximately 15% w/w of a glycol ether; (e) approximately 0.5% w/w to approximately 10% w/w ethoxylated polyethylene imine; and (f) approximately 0.05% w/w to approximately 10% w/w of the composition of a water blend of (i) sodium carbonate, (ii) approximately 1% w/w to approximately 50% w/w of the water blend of monoterpene, (iii) approximately 1% w/w to approximately 50% w/w of the water blend of N,N′-dialkyl amides, and (iv) emulsifiers;
approximately 0.5% w/w to approximately 5% w/w anionic surfactant comprising alkali C10-C14 sulfate anionic surfactant; (b) approximately 0.05% w/w to approximately 15% w/w of a C4-C8 alcohol alkoxylate nonionic surfactant having 3-9 EO; (c) approximately 0.5% to approximately 10% of a copolymer having a monomer having the structure:

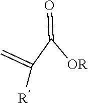

wherein R=an alkali metal, H, vinyl, a C1-C4 alkyl group, or combinations thereof, and R′=H, a C1-C4 alkyl group, or combinations thereof; (d) approximately 0.5% to approximately 15% w/w of a glycol ether; (e) approximately 0.5% w/w to approximately 10% w/w ethoxylated polyethylene imine; and (f) approximately 0.05% w/w to approximately 10% w/w of the composition of a water blend of (i) sodium carbonate, (ii) approximately 1% w/w to approximately 50% w/w of the blend of monoterpene, (iii) approximately 1% w/w to approximately 50% w/w of the blend of N,N′-dialkyl amides, and (iv) emulsifiers;
approximately 1.5% w/w to approximately 2.5% w/w anionic surfactant; (b) approximately 0.5% w/w to approximately 1.5% w/w of nonionic alcohol alkoxylate surfactant; (c) approximately 3.0% to approximately 4.0% of a copolymer having a monomer having the structure:

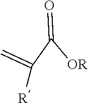

wherein R=an alkali metal, H, vinyl, a C1-C4 alkyl group, or combinations thereof, and R′=H, a C1-C4 alkyl group, or combinations thereof; (d) approximately 3.0% to approximately 6.0% w/w of a glycol ether; (e) approximately 1.5% w/w to approximately 2.5% w/w ethoxylated polyethylene imine; and (f) approximately 0.5% w/w to approximately 1.5% w/w of the composition of a water blend of (i) sodium carbonate, (ii) approximately 1% w/w to approximately 50% w/w of the blend of monoterpene, (iii) approximately 1% w/w to approximately 50% w/w of the blend of N,N′-dialkyl amides, and (iv) emulsifiers;
approximately 1.5% w/w to approximately 2.5% w/w anionic surfactant comprising alkali C10-C14 sulfate anionic surfactant; (b) approximately 0.5% w/w to approximately 1.5% w/w of a C4-C8 alcohol alkoxylate nonionic surfactant having 3-9 EO; (c) approximately 3.0% to approximately 4.0% of a copolymer having a monomer having the structure:

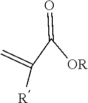

wherein R=an alkali metal, H, vinyl, a C1-C4 alkyl group, or combinations thereof, and R′=H, a C1-C4 alkyl group, or combinations thereof; (d) approximately 3.0% to approximately 6.0% w/w of a glycol ether; (e) approximately 1.5% w/w to approximately 2.5% w/w ethoxylated polyethylene imine; and (f) approximately 0.5% w/w to approximately 1.5% w/w of the composition of a water blend of (i) sodium carbonate, (ii) approximately 1% w/w to approximately 50% w/w of the blend of monoterpene, (iii) approximately 1% w/w to approximately 50% w/w of the blend of N,N′-dialkyl amides, and (iv) emulsifiers;
approximately 0.5% w/w to approximately 5% w/w anionic surfactant; (b) approximately 0.05% w/w to approximately 15% w/w of a nonionic alcohol alkoxylate surfactant; (c) approximately 0.5% to approximately 10% of a copolymer having a monomer having the structure:

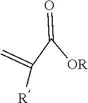

wherein R=an alkali metal, H, vinyl, a C1-C4 alkyl group, or combinations thereof, and R′=H, a C1-C4 alkyl group, or combinations thereof; (d) approximately 0.5% to approximately 15% w/w of a glycol ether; (e) approximately 0.5% w/w to approximately 10% w/w ethoxylated polyethylene imine; (f) approximately 0.05% w/w to approximately 10% w/w of the composition of a water blend of (i) sodium carbonate, (ii) approximately 1% w/w to approximately 50% w/w of the water blend of monoterpene, (iii) approximately 1% w/w to approximately 50% w/w of the water blend of N,N′-dialkyl amides, and (iv) emulsifiers; and (g) a thickening agent.
approximately 1.5% w/w to approximately 2.5% w/w anionic surfactant; (b) approximately 0.5% w/w to approximately 1.5% w/w of an alcohol alkoxylate nonionic surfactant; (c) approximately 3.0% to approximately 4.0% of a copolymer having a monomer having the structure:

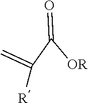

wherein R=an alkali metal, H, vinyl, a C1-C4 alkyl group, or combinations thereof, and R′=H, a C1-C4 alkyl group, or combinations thereof; (d) approximately 3.0% to approximately 6.0% w/w of a glycol ether; (e) approximately 1.5% w/w to approximately 2.5% w/w ethoxylated polyethylene imine; (f) approximately 0.5% w/w to approximately 1.5% w/w of the composition of a water blend of (i) sodium carbonate, (ii) approximately 1% w/w to approximately 50% w/w of the blend of monoterpene, (iii) approximately 1% w/w to approximately 50% w/w of the blend of N,N′-dialkyl amides, and (iv) emulsifiers; and (g) a thickening agent;
approximately 0.5% w/w to approximately 5% w/w anionic surfactant comprising alkali C10-C14 sulfate anionic surfactant; (b) approximately 0.05% w/w to approximately 15% w/w of a C4-C8 alcohol alkoxylate nonionic surfactant having 3-9 EO; (c) approximately 0.5% to approximately 10% of a copolymer having a monomer having the structure:

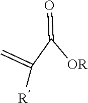

wherein R=an alkali metal, H, vinyl, a C1-C4 alkyl group, or combinations thereof, and R′=H, a C1-C4 alkyl group, or combinations thereof; (d) approximately 0.5% to approximately 15% w/w of a glycol ether; (e) approximately 0.5% w/w to approximately 10% w/w ethoxylated polyethylene imine; (f) approximately 0.05% w/w to approximately 10% w/w of the composition of a water blend of (i) sodium carbonate, (ii) approximately 1% w/w to approximately 50% w/w of the blend of monoterpene, (iii) approximately 1% w/w to approximately 50% w/w of the blend of N,N′-dialkyl amides, and (iv) emulsifiers; and (g) a thickening agent;
approximately 1.5% w/w to approximately 2.5% w/w anionic surfactant comprising alkali C10-C14 sulfate anionic surfactant; (b) approximately 0.5% w/w to approximately 1.5% w/w of a C4-C8 alcohol alkoxylate nonionic surfactant having 3-9 EO; (c) approximately 3.0% to approximately 4.0% of a copolymer having a monomer having the structure:

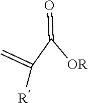

wherein R=an alkali metal, H, vinyl, a C1-C4 alkyl group, or combinations thereof, and R′=H, a C1-C4 alkyl group, or combinations thereof; (d) approximately 3.0% to approximately 6.0% w/w of a glycol ether; (e) approximately 1.5% w/w to approximately 2.5% w/w ethoxylated polyethylene imine; (f) approximately 0.5% w/w to approximately 1.5% w/w of the composition of a water blend of (i) sodium carbonate, (ii) approximately 1% w/w to approximately 50% w/w of the blend of monoterpene, (iii) approximately 1% w/w to approximately 50% w/w of the blend of N,N′-dialkyl amides, and (iv) emulsifiers; and (g) a thickening agent;
approximately 1% w/w to approximately 4% w/w anionic surfactant;
approximately 1.5% w/w to approximately 2.5% w/w anionic surfactant;
the anionic surfactant comprising an alkali alkyl sulfate;
the anionic surfactant comprising an alkali C10-C14 sulfate;
the anionic surfactant further comprising an alkali alkyl ethoxylated sulfate;
the anionic surfactant further comprising an alkali C10-C14 ethoxylated sulfate having 1 to 20 ethoxy groups;
the anionic surfactant consisting essentially of an alkali alkyl sulfate and an ethoxylated alkali alkyl ether sulfate;
the anionic surfactant consisting essentially of an alkali C10-C14 alkyl sulfate and an ethoxylated alkali C10-C14 alkyl ether sulfate;
the anionic surfactant consisting essentially of sodium lauryl sulfate and sodium lauryl ether sulfate with 1-20 ethoxy groups;
the anionic surfactant consisting of an alkali alkyl sulfate and an ethoxylated alkali alkyl ether sulfate;
the anionic surfactant consisting of an alkali C10-C14 alkyl sulfate and an ethoxylated alkali C10-C14 alkyl ether sulfate;
the anionic surfactant consisting of sodium lauryl sulfate and sodium lauryl ether sulfate with 1-20 ethoxy groups;
the anionic surfactant comprising approximately 1.5% w/w to approximately 3% w/w sodium lauryl sulfate and approximately 0.03% w/w to approximately 0.1% w/w sodium lauryl ether sulfate with 1-20 ethoxy groups;
the anionic surfactant consisting essentially of approximately 1.5% w/w to approximately 3% w/w sodium lauryl sulfate and approximately 0.03% w/w to approximately 0.1% w/w sodium lauryl ether sulfate with 1-20 ethoxy groups;
the anionic surfactant consisting of approximately 1.5% w/w to approximately 3% w/w sodium lauryl sulfate and approximately 0.03% w/w to approximately 0.1% w/w sodium lauryl ether sulfate with 1-20 ethoxy groups;
the anionic surfactant comprising approximately 2% w/w to approximately 2.5% w/w sodium lauryl sulfate and approximately 0.05% w/w to approximately 0.09% w/w sodium lauryl ether sulfate with 1-20 ethoxy groups;
the anionic surfactant consisting essentially of approximately 2% w/w to approximately 2.5% w/w sodium lauryl sulfate and approximately 0.05% w/w to approximately 0.09% w/w sodium lauryl ether sulfate with 1-20 ethoxy groups;
the anionic surfactant consisting of approximately 2% w/w to approximately 2.5% w/w sodium lauryl sulfate and approximately 0.05% w/w to approximately 0.09% w/w sodium lauryl ether sulfate with 1-20 ethoxy groups;
the anionic surfactant being substantially free of sulfonate surfactants;
the anionic surfactant being substantially free of sarcosinate surfactants;
approximately 0.1% w/w to approximately 10% w/w of a nonionic alcohol alkoxylate surfactant;
approximately 1% w/w to approximately 5% w/w of a nonionic alcohol alkoxylate surfactant;
approximately 0.5% w/w to approximately 1.5% w/w of a nonionic alcohol alkoxylate surfactant;
approximately 0.1% w/w to approximately 10% w/w of a C4-C8 alcohol alkoxylate nonionic surfactant having 3-9 EO;
approximately 1% w/w to approximately 5% w/w of a C4-C8 alcohol alkoxylate nonionic surfactant having 3-9 EO;
approximately 0.5% w/w to approximately 1.5% w/w of a C4-C8 alcohol alkoxylate nonionic surfactant having 3-9 EO;
approximately 0.1% w/w to approximately 10% w/w of a C4-C8 alcohol alkoxylate nonionic surfactant having 4-8 EO;
approximately 1% w/w to approximately 5% w/w of a C4-C8 alcohol alkoxylate nonionic surfactant having 4-8 EO;
approximately 0.5% w/w to approximately 1.5% w/w of a C4-C8 alcohol alkoxylate nonionic surfactant having 4-8 EO;
approximately 0.1% w/w to approximately 10% w/w of a C4-C8 alcohol alkoxylate nonionic surfactant having 5-7 EO;
approximately 1% w/w to approximately 5% w/w of a C4-C8 alcohol alkoxylate nonionic surfactant having 5-7 EO;
approximately 0.5% w/w to approximately 1.5% w/w of a C4-C8 alcohol alkoxylate nonionic surfactant having 5-7 EO;
approximately 1% to approximately 8% of a copolymer;
approximately 2% to approximately 6% of a copolymer;
approximately 3% to approximately 4% of a copolymer;
the copolymer having a monomer having the structure:

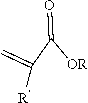

wherein R and R′=H;
the copolymer being an acrylic copolymer emulsion;
the copolymer being an anionic acrylic copolymer emulsion;
the copolymer being an anionic acrylic copolymer emulsion sold under the tradename NeoCryl™ A-500 by DSM;
the copolymer being a water-based acrylic copolymer dispersion;
the copolymer being a water-based acrylic copolymer dispersion sold under the tradename Syntran™ 1580 by Interpolymer Corporation;
the copolymer having a monomer having the structure:

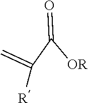

wherein R=an alkali metal and R′=H or a C1-C4 alkyl group;
the copolymer being a sodium acrylate solution;
the copolymer being a sodium acrylate solution sold under the tradename Syntran™ 4022 by Interpolymer Corporation;
the composition comprising two or more copolymers;
the composition comprising approximately 1% to approximately 8% of two or more copolymers;
the composition comprising approximately 2% to approximately 6% of two or more copolymers;
the composition comprising approximately 3% to approximately 4% of two or more copolymers;
the copolymer comprising an acrylic copolymer emulsion and a water-based acrylic copolymer dispersion;
the copolymer comprising an acrylic copolymer emulsion and a sodium acrylate copolymer;
the copolymer comprising a water-based acrylic copolymer dispersion and a sodium acrylate copolymer;
the composition comprising three or more polymers;
the composition comprising approximately 1% to approximately 8% of three or more copolymers;
the composition comprising approximately 2% to approximately 6% of three or more copolymers;
the composition comprising approximately 3% to approximately 4% of three or more copolymers;
the copolymer comprising an acrylic copolymer emulsion, a water-based acrylic copolymer dispersion, and a sodium acrylate copolymer;
the thickening agent differing from the acrylic and acrylate copolymers;
the thickening agent being a polymer;
the thickening agent being an alkali-swellable acrylic emulsion polymer;
the thickening agent being the alkali-swellable acrylic emulsion polymer sold under the trade name Carbopol Aqua 30 by Lubrizol;
the cleaning composition comprising between approximately 0.3% w/w to approximately 1% w/w of an alkali swellable acrylic emulsion polymer;
the cleaning composition comprising between approximately 0.5% w/w to approximately 1.5% w/w of the alkali swellable acrylic emulsion polymer sold under the trade name Carbopol Aqua 30 by Lubrizol;
approximately 0.5% to approximately 15% w/w of a glycol ether;
approximately 1% to approximately 10% w/w of a glycol ether;
approximately 2% to approximately 8% w/w of a glycol ether;
approximately 3% to approximately 6% w/w of a glycol ether;
the solvents comprising glycol ethers;
the solvents comprising two or more glycol ethers;
approximately 0.5% to approximately 15% w/w of two or more glycol ethers;
approximately 1% to approximately 10% w/w of two or more glycol ethers;
approximately 2% to approximately 8% w/w of two or more glycol ethers;
approximately 3% to approximately 6% w/w of two or more glycol ethers;
the glycol ethers being dipropylene glycol n-propyl ether and dipropylene glycol n-butyl ether;
the glycol ethers being dipropylene glycol n-butyl ether and propylene glycol phenyl ether;
the glycol ethers being dipropylene glycol n-propyl ether and propylene glycol phenyl ether;
the solvents comprising three or more glycol ethers;
approximately 0.5% to approximately 15% w/w of three or more glycol ethers;
approximately 1% to approximately 10% w/w of three or more glycol ethers;
approximately 2% to approximately 8% w/w of three or more glycol ethers;
approximately 3% to approximately 6% w/w of three or more glycol ethers;
the glycol ethers being dipropylene glycol n-propyl ether, dipropylene glycol n-butyl ether, and propylene glycol phenyl ether;
approximately 1.5% w/w to approximately 2.5% w/w ethoxylated polyethylene imine;
the ethoxylated polyethylene imine sold by BASF under the trade name Sokalan HP20;
approximately 0.5% w/w to approximately 1.5% w/w of the composition of a water blend of (i) sodium carbonate, (ii) approximately 1% w/w to approximately 50% w/w of the water blend of monoterpene, (iii) approximately 1% w/w to approximately 50% w/w of the water blend of N,N′-dialkyl amides, and (iv) emulsifiers;
approximately 75% w/w to approximately 90% w/w water;
the composition further comprising a second nonionic surfactant;
the composition further comprising approximately 0.05% w/w to approximately 1.5% w/w of a second nonionic surfactant;
the second nonionic surfactant comprising caprylyl/decyl glucoside, deceth-5, PPG-6-laureth-3, and combinations thereof;
the second nonionic surfactant comprising caprylyl/decyl glucoside;
the second nonionic surfactant comprising deceth-5;
the second nonionic surfactant comprising PPG-6-laureth-3;
the second nonionic surfactant comprising a blend of caprylyl/decyl glucoside, deceth-5, and PPG-6-laureth-3 sold by BASF under the tradename Dehypound Advanced;
the composition further comprising approximately 0.5% w/w to approximately 1.5% w/w of a second nonionic surfactant comprising a blend of caprylyl/decyl glucoside, deceth-5, and PPG-6-laureth-3 sold by BASF under the tradename Dehypound Advanced;
the composition further comprising a sequestrant;
the sequestrant being iminodisuccinic acid tetrasodium salt (IDS), methylglycine diacetic acid trisodium salt (MGDA), ethylenediaminetetraacetic acid (EDTA), tetrasodium glutamate diacetate (GLDA), tetrakis hydroxymethyl phosphonium sulfate (THPS), diethylenetriaminepentaacetic acid (DTPA), or combinations thereof;
the sequestrant being iminodisuccinic acid tetrasodium salt (IDS);
the composition comprising a preservative;
the preservative being potassium sorbate, 5-chloro-2-methyl-4-isothiazolin-3-one, 2-methyl-4-isothiazolin-3-one, or any combination thereof;
the preservative being 1,2-benzisothiaol-3-one, 2-methylisothiazol-3-one, or combinations thereof;
further comprising a fragrance;
the composition comprising an antioxidant;
the antioxidant being selected from the group consisting of citric acid, benzoic acid, ascorbic acid, phenol compounds, and combinations thereof;
the phenol compounds being selected from the group consisting of butoxyhydroxytoluene, butoxyhydroxyanisole, and combinations thereof;
the antioxidant being butylated hydroxytoluene;
the composition comprising a pH adjuster;
the composition comprising an inorganic pH adjuster;
the pH adjuster being sodium hydroxide;
the composition being substantially free of enzymes;
the composition being substantially free of hydrogen peroxide;
the composition being substantially free of a hypohalite;
the composition being substantially free of percarboxylic acid;
the composition being substantially free of TAED;
the composition being substantially free of manganese salt catalyst;
the composition being substantially free of C12;
the composition being substantially free of polysaccharide thickeners;
the composition being substantially free of xanthan gum;
the composition being a liquid;
the composition being a cloudy white liquid;
the composition being a water-thin liquid at room temperature (i.e., 20° C.);
the composition having a pH ranging from approximately 7 to approximately 9 in at 20° C.;
the cleaning composition being a soft surface cleaning composition;
the cleaning composition being an inanimate soft surface cleaning composition;
and/or
the soft surface cleaning composition being a carpet cleaning composition.

Methods of removing stains from soft surfaces are also disclosed. Any of the compositions disclosed above are applied to the stain. The methods may include one or more of the following aspects:
ejecting the composition from an orifice onto the stain;
applying the composition to the stain with a trigger sprayer;
applying the composition to the stain with a roll-on applicator;
applying the composition to the stain with a spot scrubber;
rubbing the composition into the stain in a circular motion;
rubbing the composition into the stain in a circular motion from starting from the outer periphery of the circle and moving inward;
rubbing the composition into the stain in a circular motion using the scrub head of the spot scrubber;
rubbing the composition into the stain in a circular motion starting from the outer circumference of the circle and moving inward using the scrub head of the spot scrubber;
leaving the composition on the stain for approximately 1 second to approximately 10 minutes;
leaving the composition on the stain for approximately 10 second to approximately 8 minutes;
leaving the composition on the stain for approximately 30 seconds to approximately 7 minutes;
leaving the composition on the stain for approximately 1 minute to approximately 6 minutes;
blotting or rubbing the stain and composition with a rinse sponge or cloth;
repeating the process if a ring appears on the soft surface;
the method being substantially free of a clean water rinse step;
the method being substantially free of a soft surface rinse step;
the method being substantially free of any requirement to rinse the soft surface rinse with water;
the method being substantially free of a dilution step;
the method being substantially free of a water dilution step;
the stain being an oxidizable stain;
the stain being cola;
the stain being grape juice;
the stain being dirty motor oil;
the stain being wine;
the stain being tomato sauce;
the stain being blood;
the stain being tea;
the stain being coffee;
the stain being dressing;
the stain being food grease;
the stain being food oil;
the stain being vegetable oil;
the stain being an oil based stain;
the stain being a grass stain;
the stain being a particulate stain;
the stain being an ink stain;
the soft surface being inanimate;
the soft surface being a textile;
the soft surface being a carpet;
the carpet being nylon, polyester, olefin, wool, or combinations thereof;
the carpet being nylon;
the carpet being polyester;
the carpet being olefin; and/or
the carpet being wool.

### BRIEF DESCRIPTION OF THE SEVERAL VIEWS OF THE DRAWINGS

For a further understanding of the nature and objects of the present invention, reference should be made to the following detailed description, taken in conjunction with the accompanying drawings. It is to be noted, however, that the drawings illustrate only certain embodiments and are therefore not to be considered limiting of its scope, for the scope of the disclosed subject matter encompasses other embodiments as well. The drawings are not necessarily to scale, emphasis generally being placed upon illustrating the features of certain embodiments.

FIG. 1 is a picture of exemplary packaging for the disclosed compositions;

FIGS. 2a, 2b, and 2c are pictures of carpet stains treated with a comparative formulation (FIG. 2a), the disclosed composition (FIG. 2b), and water (FIG. 2c).

### TERMS AND DEFINITIONS

As used herein:
the terms “approximately” and “about” mean plus or minus 10% of the value stated;
the term “a” or “an” means one or more;
any and all ranges are inclusive of their endpoints, e.g. a ranging from 1% w/w to 10% w/w based on the total weight of the composition includes 1% w/w and 10% w/w and any concentration between 1% w/w and 10% w/w;
when an ingredient does not contain close or equal to 100% w/w active material, two percentages may be provided: one for the weight of the raw material and one for the weight of the active in the raw material. For example, 7% w/w of sodium lauryl sulfate raw material contains approximately 30% w/w sodium lauryl sulfate in water, which equates to approximately 2.1% w/w of sodium lauryl sulfate in the composition. This is represented as 7% w/w (2.1% w/w) of sodium lauryl sulfate;
the abbreviation EO refers to a repeating ethoxy group, also known as an ethylene oxide or oxirane group, represented by the formula —(O—CH₂—CH₂)—;
the term “comprising” is inclusive or open-ended and does not exclude any additional elements; the term “consisting of” excludes any additional elements; and the term “consisting essentially of” is in-between, only permitting additional elements that do not materially affect characteristics of the product or process;
the phrase “substantially free” means a concentration of less than 0.3 g/L, preferably less than 0.2 g/L, more preferably less than 0.1 g/L, and most preferably less than 0.05 g/L;
the term “liquid” means a state of matter that conforms to the shape of the container in which it is held at room temperature (18-23° C.) and which acquires a defined surface in the presence of gravity; the term “liquid” is readily distinguishable from the terms “solid” and “gas.” Liquids are not pastes, which behaves as a solid until a sufficiently large load or stress is applied, even though a paste is also known as a Bingham plastic fluid;
the term “oxidizable stain” refers to stains that have color. Exemplary oxidizable stains include, but are not limited to, coffee, crayon, dye, grape juice, ink, lipstick, markers, mildew, mould, mustard, rust, tannin, tea, tobacco, and wine. One of ordinary skill in the art will recognize that these stains are typically the hardest to clean.

### DETAILED DESCRIPTION

Cleaning compositions comprising surfactants, solvents, and polymers are disclosed. The cleaning compositions are substantially free of peroxide or bleaching ingredients.

The disclosed cleaning compositions comprise approximately 0.5% w/w to approximately 5% w/w anionic surfactant, preferably approximately 1% w/w to approximately 4% w/w, and more preferably approximately 1.5% w/w to approximately 2.5% w/w. The anionic surfactant may comprise an alkali alkyl sulfate, preferably an alkali C10-C14 sulfate. One of ordinary skill in the art will recognize that sodium lauryl sulfate is an inexpensive, readily available, and effective alkali C10-C14 sulfate that may be used in the teachings herein. Sodium lauryl sulfate is well known to provide effective cleaning. The anionic surfactant may optionally further comprise an alkali alkyl ethoxylated sulfate, preferably an alkali C10-C14 ethoxylated sulfate having 1 to 20 ethoxy groups. In one alternative the anionic surfactant comprises, consists essentially of, or consists of an alkali alkyl sulfate and an ethoxylated alkali alkyl ether sulfate, preferably an alkali C10-C14 alkyl sulfate and an ethoxylated alkali C10-C14 alkyl ether sulfate with 1-20 ethoxy groups. In one alternative, the anionic surfactant comprises, consists essentially of, or consists of approximately 1.5% w/w to approximately 3% w/w by weight of the composition of sodium lauryl sulfate and approximately 0.03% w/w to approximately 0.1% w/w by weight of the composition of sodium lauryl ether sulfate with 1-20 ethoxy groups. In another alternative, the anionic surfactant comprises, consists essentially of, or consists of approximately 2% w/w to approximately 2.5% w/w by weight of the composition of sodium lauryl sulfate and approximately 0.05% w/w to approximately 0.09% w/w by weight of the composition sodium lauryl ether sulfate with 1-20 ethoxy groups. Due to the low concentration of the ether sulfate, the range of the number of ethoxy groups may vary without impacting performance. Preferably, the anionic surfactant is substantially free from sulfonates and/or sarcosinates.

The disclosed cleaning compositions comprise approximately 0.05% w/w to approximately 15% w/w of a nonionic alcohol alkoxylate surfactant, preferably approximately 0.1% w/w to approximately 10% w/w, more preferably approximately 1% w/w to approximately 5% w/w, and most preferably approximately 0.5% w/w to approximately 1.5% w/w. The nonionic alcohol alkoxylate may be a C4-C8 alcohol ethoxylate having 3-9EO, preferably 4-8 EO, and more preferably 5-7 EO.

The disclosed cleaning compositions comprise approximately 0.5% w/w to approximately 10% w/w of a copolymer, preferably approximately 1% w/w to approximately 8% w/w, more preferably approximately 2% w/w to approximately 6%, and most preferably approximately 3% w/w to approximately 4% w/w. The copolymer prevents soil from being deposited on the soft surface. The copolymer has a monomer having the structure:

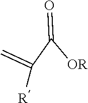

wherein R=an alkali metal, H, vinyl, a C1-C4 alkyl group, or combinations thereof, and R′=H, a C1-C4 alkyl group, or combinations thereof. These copolymers do not provide a significant increase in the viscosity of the composition.

In one embodiment, R and R′ may both be H, resulting in an acrylic monomer. The acrylic monomer may be included in an acrylic copolymer emulsion, preferably an anionic copolymer emulsion. The disclosed cleaning compositions may comprise approximately 0.1% w/w to approximately 1% w/w, preferably from approximately 0.2% to approximately 0.9% w/w, more preferably from approximately 0.3% w/w to approximately 0.7% w/w of the acrylic copolymer emulsion. Exemplary commercially available anionic copolymer emulsions suitable for use in the teachings herein include NeoCryl™ A-500 from DSM.

Alternatively, the acrylic monomer may be present in a water-based acrylic copolymer dispersion. The disclosed cleaning compositions may comprise approximately 0.01% w/w to approximately 1% w/w, preferably from approximately 0.05% to approximately 0.5% w/w, more preferably from approximately 0.1% w/w to approximately 0.3% w/w of the water-based acrylic copolymer dispersion. Exemplary commercially available water-based acrylic copolymer dispersions suitable for use in the teachings herein include Syntran™ 1580 from Interpolymer Corporation.

Alternatively, R′ may be an alkali metal or H and R=vinyl, a C1-C4 alkyl group, or combinations thereof. For example, R′ may be sodium and R=H, producing a sodium acrylate monomer. The sodium acrylate monomer may be present in a sodium acrylate solution. The disclosed cleaning compositions may comprise approximately 0.5% w/w to approximately 5% w/w, preferably from approximately 0.75% to approximately 2% w/w, more preferably from approximately 1% w/w to approximately 1.5% w/w of the sodium acrylate solution. Exemplary commercially available sodium acrylate solutions suitable for use in the teachings herein include Syntran™ 4022 from Interpolymer Corporation.

The cleaning composition may comprise two or more copolymers. The concentration of the two or more polymers in the cleaning composition may range from approximately 1% w/w to approximately 8% w/w, preferably from approximately 2% w/w to approximately 6% w/w, and more preferably from approximately 3% w/w to approximately 4% w/w. For example, the copolymer may comprise an acrylic copolymer emulsion and a water-based acrylic copolymer dispersion. In these embodiments, the active weight ratio of the acrylic copolymer emulsion to the water-based acrylic copolymer dispersion ranges from approximately 2.5:1 to approximately 3.5:1, preferably from approximately 2.75:1 to approximately 3.25:1. Alternatively, the copolymer may comprise an acrylic copolymer emulsion and a sodium acrylate copolymer. In these embodiments, the active weight ratio of the sodium acrylate solution to the acrylic copolymer emulsion ranges from approximately 1:1 to approximately 3:1, preferably from approximately 1.5:1 to approximately 2.5:1. In another alternative, the copolymer may comprise a water-based acrylic copolymer dispersion and a sodium acrylate copolymer. In these embodiments, the active weight ratio of the sodium acrylate copolymer to the water-based acrylic copolymer ranges from approximately 3:1 to approximately 9:1, preferably from approximately 5:1 to approximately 7:1.

The cleaning composition may comprise three or more polymers. The concentration of the three or more polymers in the cleaning composition may range from approximately 1% w/w to approximately 8% w/w, preferably from approximately 2% w/w to approximately 6% w/w, and more preferably from approximately 3% w/w to approximately 4% w/w. The copolymer may comprise an acrylic copolymer emulsion, a water-based acrylic copolymer dispersion, and a sodium acrylate copolymer. The active weight ratio of the sodium acrylate copolymer to the acrylic copolymer emulsion to the water-based acrylic copolymer is approximately 6:3:1.

The disclosed cleaning compositions comprise approximately 0.5% w/w to approximately 15% w/w of a glycol ether, preferably approximately 1% w/w to approximately 10% w/w, more preferably approximately 2% w/w to approximately 8% w/w, and most preferably approximately 3% w/w to approximately 6% w/w. The glycol ether helps remove ink, gum, clay, and particulate stains. Exemplary glycol ethers suitable for use in the teachings herein include dipropylene glycol n-propyl ether, dipropylene glycol n-butyl ether, propylene glycol phenyl ether, and combinations thereof.

The disclosed cleaning compositions may comprise two or more glycol ethers. The concentration of the two or more glycol ethers in the cleaning composition may range from approximately 0.5% w/w to approximately 15% w/w, preferably from approximately 1% to approximately 10% w/w, more preferably from approximately 2% w/w to approximately 8% w/w; and most preferably from approximately 3% w/w to approximately 6% w/w. For example, the glycol ethers may comprise dipropylene glycol n-propyl ether and dipropylene glycol n-butyl ether. Alternatively, the glycol ethers may comprise dipropylene glycol n-butyl ether and propylene glycol phenyl ether. In another alternative, the glycol ethers may comprise dipropylene glycol n-propyl ether and propylene glycol phenyl ether.

The disclosed cleaning compositions may comprise three or more glycol ethers. The concentration of the three or more glycol ethers in the cleaning composition may range from approximately 0.5% w/w to approximately 15% w/w, preferably from approximately 1% to approximately 10% w/w, more preferably from approximately 2% w/w to approximately 8% w/w; and most preferably from approximately 3% w/w to approximately 6% w/w. For example, the glycol ethers may comprise a combination of dipropylene glycol n-propyl ether, dipropylene glycol n-butyl ether, and propylene glycol phenyl ether.

The disclosed cleaning compositions comprise approximately 0.5% w/w to approximately 10% w/w ethoxylated polyethylene imine, preferably approximately 1.5% w/w to approximately 2.5% w/w. The polyethylene imine helps remove wine, tomato sauce, and other oxidizable stains from soft surfaces. Exemplary commercially available ethoxylated polyethylene imines suitable for use in the teachings herein include Sokalan™ HP20 from BASF.

The disclosed cleaning compositions may further include approximately 0.5% w/w to approximately 1.5% w/w of the composition of a water blend of (i) sodium carbonate, (ii) approximately 1% w/w to approximately 50% w/w of the water blend of monoterpene, (iii) approximately 1% w/w to approximately 50% w/w of the water blend of N,N′-dialkyl amides, and (iv) emulsifiers. Exemplary commercially available blends suitable for use in the teachings herein include Steposol Citri-Met from Stephan. The blend is useful for removing marker, blood, and solvent stains from soft surfaces.

The disclosed cleaning compositions further comprise water, resulting in liquid compositions having a water-like viscosity at room temperature (i.e., ~20° C.). The combination of materials in the disclosed cleaning compositions produce a cloudy white 25 liquid. The resulting liquid compositions have a pH ranging from approximately 7 to approximately 9 at 20° C.

The disclosed cleaning compositions may be used to clean soft surfaces. The disclosed cleaning compositions are particularly suitable for cleaning inanimate soft surfaces, such as carpets and upholstery.

The disclosed cleaning compositions remove oxidable stains without the use of enzymes or bleaches. As a result, the disclosed cleaning compositions are substantially free of enzymes, hydrogen peroxide, hypohalites, percarboxylic acids, TAED, manganese salt catalyst, and C12. More particularly, the disclosed cleaning composition are substantially free of proteases, lipases, amylases, cellulases, pectinases, laccases, catalases, oxidases, or any combinations thereof.

In one preferred embodiment, the disclosed cleaning compositions further comprises a thickening agent. The thickening agent is a polymer that differs from the copolymers disclosed above. The thickening agent helps prevent leakage of the cleaning composition from its packaging. The thickening agent may be an alkali-swellable acrylic emulsion polymer. Exemplary commercially available alkali-swellable acrylic emulsion polymers include Carbopol™ Aqua 30 from Lubrizol.

The concentration of the thickening agent is low enough to maintain the water-like viscosity of the disclose cleaning compositions. If the concentration of the thickening agent is too high, the disclosed cleaning compositions may have difficulty permeating the carpet or upholstery fibers. The concentration of the thickening agent in the cleaning composition may range from approximately 0.3% w/w to approximately 1% w/w, preferably from approximately 0.5% w/w to approximately 1.5% w/w.

Care must be taken to avoid selecting any thickening agents that attract dirt. As shown in the examples that follow, formulations containing xanthan gum leave a residual ring. As a result, the disclosed cleaning compositions are substantially free of polysaccharide thickeners, particularly cellulose or xanthan gum.

The disclosed cleaning compositions may further optionally comprise one or more additional nonionic surfactants. The nonionic surfactants may be useful on wine, tomato sauce, and other oxidizable stains. The concentration of the one or more additional nonionic surfactants may range from approximately 0.05% w/w to approximately 1.5% w/w. The additional nonionic surfactants may comprise caprylyl/decyl glucoside, deceth-5, PPG-6-laureth-3, or combinations thereof.

Exemplary commercially available nonionic blends include Dehypound Advanced from BASF. The Technical Bulletin from BASF for Dehypound Advanced notes that the product may lose cleaning performance when combined with glycol others. Contrary to the BASF Technical Bulletin for Dehypound Advanced and as shown in the examples that follow, no impact was observed from the combination with the glycol ethers in the disclosed cleaning composition.

The disclosed cleaning compositions may further optionally comprise a sequesterant. The sequesterant helps protect against metal contamination or ions from hard water. Exemplary sequestrants suitable for use herein include iminodisuccinic acid tetrasodium salt (IDS), methylglycine diacetic acid trisodium salt (MGDA), ethylenediaminetetraacetic acid (EDTA), tetrasodium glutamate diacetate (GLDA), tetrakis hydroxymethyl phosphonium sulfate (THPS), diethylenetriaminepentaacetic acid (DTPA), or combinations thereof. As shown in the Examples that follow, suitable results have been obtained using IDS as sequesterant.

The disclosed cleaning compositions may further optionally comprise a preservative. Exemplary preservatives include potassium sorbate, 5-chloro-2-methyl-4-isothiazolin-3-one, 2-methyl-4-isothiazolin-3-one, or any combination thereof. As shown in the Examples that follow, suitable results have been obtained using a combination of 1,2-benzisothiaol-3-one and 2-methylisothiazol-3-one as preservative.

The disclosed cleaning compositions may further optionally comprise a fragrance. When a fragrance is included in the disclosed compositions, an antioxidant may be combined with the fragrance to help extend the stability of the fragrance. Exemplary antioxidants suitable for use with the fragrance include phenol compounds. The phenol compounds may be selected from the group consisting of butoxyhydroxytoluene, butoxyhydroxyanisole, and combinations thereof. Preferably, the antioxidant is butylated hydroxytoluene.

The disclosed cleaning compositions may optionally further comprise a pH adjuster. The pH adjuster may be an inorganic pH adjuster, such as potassium or sodium hydroxide. When necessary, the pH adjuster adjusts the pH of the disclosed cleaning compositions to a pH ranging from approximately 7 to approximately 9 at 20° C.

Exemplary soft surface cleaning compositions comprise:
approximately 0.5% w/w to approximately 5% w/w anionic surfactant, preferably approximately 1.5% w/w to approximately 2.5% w/w;
approximately 0.05% w/w to approximately 15% w/w of a nonionic alcohol alkoxylate surfactant, preferably approximately 0.5% w/w to approximately 1.5% w/w; approximately 0.5% to approximately 10% of acrylic and acrylate copolymers, preferably approximately 3% w/w to approximately 4% w/w;
approximately 0.5% to approximately 15% w/w of glycol ethers, preferably approximately 3% w/w to approximately 6% w/w;
approximately 0.5% w/w to approximately 10% w/w polyethylene imine, preferably approximately 1.5% w/w to approximately 2.5% w/w;
approximately 0.05% w/w to approximately 10% w/w, preferably approximately 0.5% w/w to approximately 1.5% w/w, of the composition of a water blend of (a) sodium carbonate, (b) approximately 1% w/w to approximately 50% w/w of the blend of monoterpene, (c) approximately 1% w/w to approximately 50% w/w of the blend of N,N′-dialkyl amides, and emulsifiers. In one embodiment, the blend comprises sodium carbonate, lemon or pine oil, and N,N′-dimethyl-9-decenamide. N,N′-dimethyl-9-decenamide may be sourced from Stepan as Steposol™ MET10U. Alternatively, the blend may be purchased from Stepan as Steposol™ Citri-met.

Particularly preferred soft surface cleaning compositions comprise:
approximately 0.5% w/w to approximately 5% w/w anionic surfactant, preferably approximately 1.5% w/w to approximately 2.5% w/w;
approximately 0.05% w/w to approximately 15% w/w of a nonionic alcohol alkoxylate surfactant, preferably approximately 0.5% w/w to approximately 1.5% w/w;
approximately 0.5% to approximately 10% of acrylic and acrylate copolymers, preferably approximately 3% w/w to approximately 4% w/w;
approximately 0.5% to approximately 15% w/w of glycol ethers, preferably approximately 3% w/w to approximately 6% w/w;
approximately 0.5% w/w to approximately 10% w/w polyethylene imine, preferably approximately 1.5% w/w to approximately 2.5% w/w;
approximately 0.4% w/w to approximately 1.4% w/w thickening agent;
approximately 0.05% w/w to approximately 10% w/w, preferably approximately 0.5% w/w to approximately 1.5% w/w, of the composition of a water blend of (a) sodium carbonate, (b) approximately 1% w/w to approximately 50% w/w of the blend of monoterpene, (c) approximately 1% w/w to approximately 50% w/w of the blend of N,N′-dialkyl amides, and emulsifiers. In one embodiment, the blend comprises sodium carbonate, lemon or pine oil, and N,N′-dimethyl-9-decenamide. N,N′-dimethyl-9-decenamide may be sourced from Stepan as Steposol™ MET10U. Alternatively, the blend may be purchased from Stepan as Steposol™ Citri-met.

A particularly preferred soft surface cleaning composition comprises:
approximately 1.5% w/w to approximately 2.5% w/w sodium lauryl sulfate;
approximately 0.03% w/w to approximately 1.0% w/w sodium lauryl ether sulfate;
approximately 1.0% w/w to approximately 2.0% w/w acrylic copolymer emulsion sold by DSM under the trade name NeoCryl™ A-550;
approximately 1.0% w/w to approximately 1.5% w/w of a sodium acrylate copolymer sold by Zschimmer & Schwartz Interpolymer Inc. under the tradename Syntran™ 4022 or sold by Yigitoglu Kimya A. S. under the tradename Ecopol YK3000; approximately 0.15% w/w to approximately 0.2% w/w of an acrylic copolymer sold by Zschimmer & Schwartz Interpolymer Inc. under the tradename Syntran™ 1580 or Syntran™ 4125;
approximately 2.0% w/w to approximately 3.0% w/w dipropylene glycol n-propyl ether;
approximately 0.5% w/w to approximately 1.5% w/w of a C4-C8 alcohol ethoxylate with 5 EO;
approximately 1.5% w/w to approximately 2.5% w/w polyethylene imine sold by BASF under the trade name Sokalan™ HP 20;
approximately 0.5% w/w to approximately 1.5% w/w of a nonionic surfactant blend of caprylyl/decyl glucoside, deceth-5, and PPG-6-laureth-3 sold by BASF under the tradename Dehypound™ Advanced;
approximately 0.5% w/w to approximately 1.5% w/w dipropylene glycol n-butyl ether;
approximately 0.5% w/w to approximately 1.5% w/w propylene glycol phenyl ether;
approximately 0.5% w/w to approximately 1.5% w/w of a water blend of (i) sodium carbonate, (ii) approximately 1% w/w to approximately 50% w/w of the water blend of monoterpene, (iii) approximately 1% w/w to approximately 50% w/w of the water blend of N,N′-dialkyl amides, and (iv) emulsifiers sold by Stepan under the trade name Steposol™ Citri-met;
approximately 0.4% w/w to approximately 1.4% w/w an alkali-swellable acrylic emulsion polymer sold by Lubrizol under the tradename Carbopol™ Aqua 30;
with the balance water and the composition pH adjusted to pH to 8±0.1 by sodium hyrdroxide solution.

A more particularly preferred soft surface cleaning composition comprises:
approximately 1.5% w/w to approximately 2.5% w/w sodium lauryl sulfate;
approximately 0.03% w/w to approximately 1.0% w/w sodium lauryl ether sulfate;
approximately 1.0% w/w to approximately 2.0% w/w acrylic copolymer emulsion sold by DSM under the trade name NeoCryl™ A-550;
approximately 0.5% w/w to approximately 1.0% w/w tetrasodium iminodisuccinate;
approximately 1.0% w/w to approximately 1.5% w/w of a sodium acrylate copolymer sold by Zschimmer & Schwartz Interpolymer Inc. under the tradename Syntran™ 4022 or sold by Yigitoglu Kimya A. S. under the tradename Ecopol YK3000;
approximately 0.15% w/w to approximately 0.2% w/w of an acrylic copolymer sold by Zschimmer & Schwartz Interpolymer Inc. under the tradename Syntran™ 1580 or Syntran™ 4125;
approximately 2.0% w/w to approximately 3.0% w/w dipropylene glycol n-propyl ether;
approximately 0.5% w/w to approximately 1.5% w/w of a C4-C8 alcohol ethoxylate with 5 EO;
approximately 0.005% w/w to approximately 0.025% w/w butylated hydroxytoluene;
approximately 0.0025% w/w to approximately 0.0075% w/w 1,2-benzisothiazol-3(2H)-one;
approximately 0.0025% w/w to approximately 0.0075% w/w 2-methylisothiazol-3(2H)-one;
approximately 1.5% w/w to approximately 2.5% w/w Sokalan™ HP 20 multifunctional a polyethylene imine sold by BASF under the trade name Sokalan™ HP 20;
approximately 0.5% w/w to approximately 1.5% w/w Dehypound™ Advanced nonionic surfactant blend;
approximately 0.5% w/w to approximately 1.5% w/w dipropylene glycol n-butyl ether;
approximately 0.5% w/w to approximately 1.5% w/w propylene glycol phenyl ether;
approximately 0.5% w/w to approximately 1.5% w/w Steposol™ Citri-met nonionic surfactant blend;
approximately 0.4% w/w to approximately 1.4% w/w Carbopol™ Aqua 30 alkali-swellable acrylic emulsion polymer; 0% w/w to approximately 0.25% w/w fragrance;
with the balance water and the composition pH adjusted pH to 8±0.1 by sodium hydroxide solution.

Methods of removing stains from soft surfaces using the cleaning compositions disclosed above are also disclosed. Exemplary soft surfaces include but are not limited to textiles comprising nylon, polyester, olefin, wool, or combinations thereof, preferably nylon, polyester, wool, or combinations thereof. Particularly preferred soft surfaces are carpets made from any of these materials or any combination of these materials. One of ordinary skill in the art will recognize that carpets contain more surface area than standard soft surfaces, such as clothing or upholstery, making cleaning more complicated.

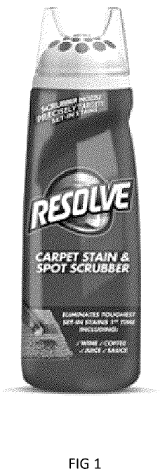

Any of the compositions disclosed above are applied to the stain. The composition should be applied to cover the entire stain surface. The composition may be applied by ejecting the composition from an orifice. Alternatively, the composition may be applied using a trigger sprayer. In another alternative, the composition may be applied using a roll-on application. In yet another alternative, the composition may be applied using a spot scrubber similar to that shown in FIG. 1. Approximately 10 g to approximately 20 g of the composition is applied to the stain, preferably approximately 12 g to approximately 18 g, and more preferably approximately 14 g to approximately 16 g. the composition is rubbed into the stain in a circular motion, preferably starting from the outer periphery of the circle and moving inward. The scrub head of the spot scrubber shown in FIG. 1 is a preferred mechanism to rub the composition into the stain, but other mechanism may be used without departing from the teachings herein. After rubbing, the composition is left on the stain for approximately 1 second to approximately 10 minutes, preferably approximately 10 second to approximately 8 minutes, more preferably approximately 30 seconds to approximately 7 minutes, and most preferably approximately 1 minute to approximately 6 minutes. The composition may be rinsed from the soft surface for some laundry applications. However, preferably, the composition does not need to be rinsed from the soft surface. Instead, the stain is blotted or rubbed gently with a clean, damp, colorfast cloth or sponge. The cloth or sponge may be rinsed, as necessary, and the blotting step repeated until the stain is removed. If a ring appears, the entire process is repeated. As a result, the disclosed methods may be substantially free of a clean water rinse step, a dilution step, and/or a water dilution step. In other words, the composition is not rinsed from the soft surface or diluted with water or other solvents, other than any water contained on the sponge or cloth used to blot the stain.

The disclosed methods use the disclosed cleaning compositions to remove oxidizable stain, such as cola, grape juice, dirty motor oil, wine, tomato sauce, blood, tea, coffee, dressing, food grease, food oil, vegetable oil, oil based stain, grass stain, particulate stain, ink stain, or any combinations thereof.

The following examples below illustrate exemplary embodiments of the invention. It is to be understood that these examples are provided by way of illustration only and that further embodiments may be produced in accordance with the teachings of the present invention.

### EXAMPLES

The compositions in the following examples were prepared using the ingredients identified in Table A:

TABLE A

| Abbreviation | CAS | Description |
|---|---|---|
| SLS | 68585-47-7 | 29% Sodium lauryl sulfate in water, e.g., Calfoam ™ |
| | | SLS 30 LP from Pilot Chemical Company or Kopacol ™ |
| | | LS 30 NA from Kensing |
| SLES | 68585-34-2 | 70% sodium lauryl ether sulfate with 2 ethoxy groups in |
| | | 30% water, e.g., Kopacol ™ N70 NA ReNu Pro from |
| | | Kensing or Inopon ™ 24-2/70 from InChemica |
| A550 | Proprietary | 40% acrylic copolymer emulsion, e.g., NeoCryl ™ A- |
| | | 550 from DSM |
| IDS | 114589-95-6 | 34% tetrasodium iminodisuccinate in 66% water, e.g., |
| | | Baypure ™ CX 100/34% from Lanxess Deutschland |
| | | GmbH |
| 4022 | 28205-96-1 | 30% Sodium salt of acrylate copolymer in 70% water, |
| | | e.g., Syntran ™ 4022 from Zschimmer & Schwarz |
| | | Interpolymer Inc. or Ecopol YK3000 from Yigitoglu |
| | | Kimya A.S. |
| 1580 | 25035-81-8 | 18.5% acrylic copolymer in 81.5% water, e.g., |
| | | Syntran ™ 1580 or Syntran ™ 4125 from |
| | | Zschimmer & Schwarz Interpolymer Inc |
| DPNP | 29911-27-1 | 1-(1-methyl-2-propoxyethoxy)propan-2-ol or |
| | | dipropylene glycol n-propyl ether, e.g., Dowanol ™ |
| | | DPNP Glycol Ether from The Dow Chemical Company |
| C4-8 5EO | 31726-34-8 | C4-8 alcohol ethoxylate with 5 EO, e.g., Lutensol ™ |
| | | CS 6250 from BASF |
| BHT | 128-37-0 | Butylated hydroxy toluene, e.g., Purolan ™ BHT from |
| | | Lanxess Deutschland GmbH |
| BIT/MIT | 2634-33-5/ | 2.5% 1,2-benzisothiazol-3(2H-one) and 2.5% 2- |
| | 26825-20-4 | methylisothiazol-3(2H)-one in water, e.g., Acticide ™ |
| | | MBS from Thor Specialties Ltd |
| HP20 | Proprietary | 80% polyethyleneimine ethoxylated in water, e.g., |
| | | Sokalan ™ HP 20 from BASF plc |
| DA | 68515-73-1 | Blend of caprylyl/decl glucoside and deceth-5 and |
| | | PPG-6-Laureth-3 in water, e.g., Dehypound Advanced |
| | | from BASF Corp. |
| DPNB | 29911-28-1 | Dipropylene glycol n-butyl ether, e.g., Dowanol ™ |
| | | DPnB from The Dow Chemical Company |
| PPh | 770-35-4 | Propylene glycol phenyl ether, e.g., Dowanol ™ |
| | | PPh from The Dow Chemical Company |
| CM | 1300-72-7, | Blend of proprietary emulsifier, N,N-dimethyl 9- |
| | 68439-46-3, | deceamide, (d)-limonene, sodium carbonate and water, |
| | 1356964-77-6, | e.g., Steposol ™ Citri-met from Stepan Company |
| | 5989-27-5, | |
| | and 497-19-8 | |
| CA | Proprietary | 30% crosslinked acrylic emulsion copolymer in water, |
| | | e.g., Carbopol ™ Aqua 30 Polymer from Lubrizol do |
| | | Brasil Aditivos LTDA |
| NaOH | 1310-73-2 | 50% sodium hydroxide in water |
| F | Variety | Fragrance |
| H2O | 7732-18-5 | Water, e.g., deionized water |
| XG | 11388-66-2 | Xantham gum, e.g., food grade from Jungbunzlauer |

### Example 1

The ingredients in Table 1 were combined as follows.

TABLE 1

| Abbreviation | % w/w RM (% w/w active) | |
|---|---|---|
| SLS | 7 | (2.1) |
| SLES | 0.1 | (0.07) |
| A550 | 1.5 | (0.54675) |
| IDS | 0.75 | (0.255) |
| 4022 | 3.7 | (1.11) |
| 1580 | 1 | (0.185) |
| DPNP | 2.5 | |
| C4-8 5EO | 1 | |
| BHT | 0.015 | |
| BIT/MIT | 0.19 | (0.00475/0.00475) |
| HP20 | 2 | (1.6) |
| DA | 1 | |
| DPNB | 1 | |
| PPh | 1 | |
| CM | 1 | |
| CA | 0.9 | (0.27) |

| | |
|---|---|
| NaOH | To adjust pH |
| F | 0.13 |
| H2O | 75.215 |

68.715% w/w of H2O is added to a mixing tank. Mixing at a moderate speed is commenced so that no vortex is formed. 7.0% w/w of SLS is added to the H2O in the mixing tank via an automatic pump. Any residual SLS is rinsed from the pump into the mixing tank with 0.5% w/w H2O. 0.1% w/w SLES is added to the mixer. The H2O, SLS, SLES mixture is mixed for 10 minutes or longer.

1.5% w/w A550 is added via a manual pump to the mixing tank containing the H2O, SLS, and SLES. Any residual A550 is rinsed from the pump into the mixing tank with 0.5% w/w H2O. 0.75% w/w IDS is added to the mixing tank. 3.7% w/w 4022 is added to the mixing tank via automatic pump. Any residual 4022 is rinsed from the pump into the mixing tank with 0.5% w/w H2O. 1.0% w/w 4125 is added to the mixing tank via manual pump. Any residual 4125 is rinsed from the pump into the tank with 0.5% w/w H2O. 2.5% w/w DPNP is added via manual pump into the mixing tank. Any residual DPNP is rinsed from the pump into the mixing tank with 0.5% w/w H2O. 1.0% w/w C4-8 5EO is added via manual pump to the mixing tank. Any residual C4-8 5EO is rinsed from the pump into the mixing tank with 0.5% w/w H2O.

0.13% w/w F is added to a side vessel. 0.015% w/w BHT is added to the side vessel and mixed until the BHT is dissolved in the F, typically approximately 20 minutes depending on the season. One of ordinary skill in the art will recognize that dissolution occurs quicker at warmer temperatures. The contents of the side vessel are added to the mixing tank. Any residual material in the side vessel is rinsed from the pump into the mixing tank with 0.5% w/w H2O.

0.19% w/w BIT/MIT is added to the mixing tank. 2.0% w/w HP20 is added to the mixing tank via manual pump. Any residual HP20 is rinsed from the pump into the mixing tank with 0.5% w/w H2O. 1.0% DA is added to the mixing tank via manual pump. Any residual DA is rinsed from the pump into the mixing tank with 0.5% w/w H2O. 1.0% w/w DPNB is added to the mixing tank via manual pump. Any residual DPNB is rinsed from the pump into the mixing tank with 0.5% w/w H2O. 1.0% w/w PPH is added to the mixing tank via manual pump. Any residual PPH is rinsed from the pump into the mixing tank with 0.5% w/w H2O. 1.0% w/w CM is added to the mixing tank via manual pump. Any residual CM is rinsed from the pump into the mixing tank with 0.5% w/w H2O. 0.9% w/w CA is added to the mixing tank via manual pump. Any residual CA is rinsed from the pump into the mixing tank with 0.5% w/w H2O. Failure to transfer all of the residual CA from the pump into the mixing tank may result in product failure, particularly leaking.

The pH of the composition is determined neat. The target pH is 8.00±0.1. On average, approximately 0.3% w/w of 50% sodium hydroxide is needed to adjust to the target pH.

Once the target pH is reached, the turbo mixer is turned on. For a 0.4 kg batch prepared in a 9000 kg mixing tank, the mixing speed is approximately 84 RPM for approximately 5 minutes. One of ordinary skill in the art will recognize that different mixing tanks and batch sizes may utilize a different mixing speed and time without departing from the teachings herein. The turbo mixer is turned off and samples sent to quality control for analysis.

The resulting composition is a cloudy white solution having a pH ranging from 7.5 to 8.5 (this batch was pH=7.67), a specific gravity ranging from 1.0 to 1.03 (this batch was 1.0157), and 7-9% w/w solids (this batch was 8.04). The resulting composition can be used on soft fabrics, with no shaking prior to use needed or requirement to mix or dilute with water.

As shown in Table 2, stability testing of the resulting composition exhibits a stable product. These results demonstrate that the composition is expected to remain stable for up to two years at room temperature and humidity, if not longer.

TABLE 2

| | Description: | | | | |
|---|---|---|---|---|---|
| | Cloudy, white | | | Specific | |
| | water-thin | Odor: | pH: | gravity: | % Solids: |
| Conditions | solution | Characteristic | 7.5-8.5 | 1.0-1.03 | 7.0-9.0 |
| Initial | Pass | Pass | 7.67 | 1.0157 | 8.04 |
| 2 weeks at 4.5° C. | Pass | Pass | 7.95 | 1.017 | 8.12 |
| 4 weeks at 4.5° C. | Pass | Pass | 7.91 | 1.016 | 8.13 |
| 6 weeks at 4.5° C. | Pass | Pass | 7.91 | 1.017 | 7.96 |
| 12 weeks at 4.5° C. | Pass | Pass | 7.77 | 1.016 | 8.31 |
| 2 weeks at 25° C. | Pass | Pass | 7.93 | 1.016 | 8.05 |
| 4 weeks at 25° C. | Pass | Pass | 7.86 | 1.016 | 8.04 |
| 6 weeks at 25° C. | Pass | Pass | 7.91 | 1.016 | 8.17 |
| 12 weeks at 25° C. | Pass | Pass | 7.76 | 1.016 | 8.14 |
| 2 weeks at | Pass, slightly | Pass | 7.92 | 1.014 | 8.14 |
| 40° C./75% RH* | clearer | | | | |
| 4 weeks at | Pass, slightly | Pass | 7.84 | 1.016 | 7.82 |
| 40° C./75% RH* | clearer | | | | |
| 6 weeks at | Pass, slightly | Pass, slightly | 7.89 | 1.016 | 7.95 |
| 40° C./75% RH* | clearer | less intense | | | |
| 12 weeks at | Pass, slightly | Pass, slightly | 7.74 | 1.016 | 8.36 |
| 40° C./75% RH* | clearer | less intense | | | |
| 2 weeks at 50° C. | Pass, slightly | Pass | 7.93 | 1.014 | 8.23 |
| | clearer | | | | |
| 4 weeks at 50° C. | Pass, slightly | Pass | 7.79 | 1.016 | 8.11 |
| | clearer | | | | |
| 6 weeks at 50° C. | Pass, slightly | Pass, slightly | 7.89 | 1.016 | 8.28 |
| | clearer, yellow, | less intense | | | |
| | leakage observed | | | | |
| | from valve | | | | |
| Freeze/Thaw** | Pass | Pass | 7.79 | 1.016 | 8.26 |

*RH = relative humidity
**Freeze/Thaw - testing was conducted after completion of 3 separate freeze/thaw cycles of 12 hours at −10° C. and 12 hours at room temperature (~20° C.).

### Example 2—Comparative Stain Removal Testing

The stain removing performance of the composition prepared in Example 1 was compared to that of water and a commercially available stain remover. The publicly available listing of ingredients in the commercially available stain remover are shown in Table 3 below.

TABLE 3

Raw Materials
<5% anionic and nonionic surfactants
Oxygen-based bleaching agent
Perfumes

The initial color of sample carpet pieces was determined using a spectrophotometer. The sample carpet pieces were cut pile, tufted, non-dyed, 100% nylon having yarn weight=1 kg/m² (30 oz/sq yard) and pile height=5.1 mm (0.201 inches). Different stains were applied to the carpet pieces for a specified period of time, either 24 hours or 7 days. The 7-day stains are equivalent to set-in stains. 15 g of the exemplary product from Example 1, the comparative product of Table 3, or water (each, a test sample) was applied to the stain using an applicator similar to that shown in FIG. 1 until the stain was completely covered with test sample. Each test sample was scrubbed into the stain for approximately 15 to approximately 30 seconds. The scrubbed-in test sample remained on the stain for approximately 5 minutes. A clean, damp cloth was used to rub and remove the test sample and stain from the carpet. The final color of the sample carpet pieces was determined. The change of color from the initial to final measurement should be small to demonstrate no residual stain or test sample impact on the color of the carpet. For each stain, four carpet pieces were tested and the results averaged. A comparison of the results from the composition of Example 1 to water and the commercial formulation of Table 3 is provided in Table 4 below.

TABLE 4

| | 24 hour | 24 hour | 7 day | 7 day |
|---|---|---|---|---|
| | stain vs | stain vs | stain vs | stain vs |
| Stain | water | commercial | water | commercial |
| Cola | S | S | S | S |
| Grape Juice | S | P | S | S |
| Dirty Motor Oil | S | S | S | S |
| Wine | S | P | S | I |
| Tea | S | P | S | I |
| Coffee | S | P | S | S |
| Dressing | S | P | S | S |
| Chocolate Sauce | P | I | P | P |
| Food Grease/Oil | S | S | S | S |
| Vegetable Oil | S | S | S | S |
| Make up | S | P | S | S |
| Gravy | S | P | S | S |
| Tomato Sauce | S | S | S | S |
| Mud | S | S | S | S |
| Mustard | P | P | P | P |
| Pet Stain | S | P | S | S |

S = Superior
P = Parity
I = Inferior

As can be seen in Table 4 and would be expected, the composition of Example 1 provided superior removal of most stains when compared to water. The composition of Example 1 and water provide equivalent stain removal of both 24-hour and 7-day chocolate sauce and mustard.

The composition of Example 1 provided superior stain removal of 24-hour cola, dirty motor oil, food grease/oil, vegetable oil, tomato sauce, and mud as compared to the commercially available product of Table 3. Except for chocolate sauces, the commercial formulation of Table 3 and the composition of Example 1 provided equivalent stain removal for 24-hour grape juice, wine, tea, coffee, dressing, make up, gravy, mustard, and pet stain. However, for the 7-day set-in stains, the composition of Example 1 provides superior stain removal of cola, grape juice, dirty motor oil, coffee, dressing, food grease/oil, vegetable oil, make up, gravy, tomato sauce, mud, and pet stain as compared to the commercial formulation of Table 3. These results demonstrate that the disclosed compositions are as effective, if not more effective, at oxidizable stain removal than formulations containing oxygen-based bleaching agents.

### Example 3—Comparative Deleterious Substrate Testing

The initial color of sample carpet pieces was determined using a spectrophotometer. 15 g of the same test samples used in Example 2 was applied using an applicator similar to that shown in FIG. 1 and scrubbed into the carpet for approximately 15 to approximately 30 seconds. The scrubbed-in test sample remained on the carpet piece for approximately 5 minutes. A clean, damp cloth was used to rub and remove the stain and test sample from the carpet. The final color of the sample carpet pieces was determined. The change of color from the initial to final measurement should be small to demonstrate no test sample impact (i.e., deleterious effect) on the color of the carpet. For each stain, four carpet pieces were tested and the results averaged. A comparison of the results from the composition of Example 1 to water and the commercial formulation of Table 3 is provided in Table 5 below.

TABLE 5

| Substrate Material | vs Commercial | vs Water |
|---|---|---|
| 100% Polyester Blue | P | P |
| 100% Polyester Green | P | P |
| 100% Polyester Red | P | P |
| 100% Polyester White | P | P |
| 100% Nylon Blue | P | P |
| 100% Nylon Green | P | P |
| 100% Nylon Red | P | P |
| 100% Nylon White | P | P |
| Olefin Blue | I | I |
| Olefin Brown | I | I |
| Olefin Red | I | I |
| 100% Wool Green | I | P |
| 100% Wool White | S | S |

S = Superior
P = Parity
I = Inferior

These R&D tests demonstrate that the exemplary formula of Example 1 performs superior to both water and the commercial formulation on white wool.

These results further demonstrate that the composition is as safe for most soft carpet surfaces as water, providing superior or parity results on 10 of 13 materials. The disclosed composition also performs as well as the commercial formulation on nylon and polyester materials. The high glycol ether concentration in the disclosed formula may react with the dyes in the olefin based materials.

### Example 4—Soil Deposition Testing

Soil deposition testing was performed. Product A was identical to that of Example 1. Product B had the formulation shown in Table 6:

TABLE 6

| Abbreviation | % w/w RM (% w/w active) | |
|---|---|---|
| SLS | 7 | (2.1) |
| IDS | 0.75 | (0.255) |
| 4022 | 2.7 | (0.81) |
| DPNP | 2.5 | |
| C4-8 5EO | 1 | |
| BHT | 0.02 | |
| BIT/MIT | 0.19 | (0.00475/0.00475) |
| HP20 | 2 | (1.6) |

| | |
|---|---|
| DPNB | 1 |
| PPh | 1 |
| XG | 0.1 |
| F | 0.13 |
| H2O | 81.72 |

Product B was a colorless, transparent solution with a pH of 6.17, a specific gravity of 1.01, and 6.9% solids.

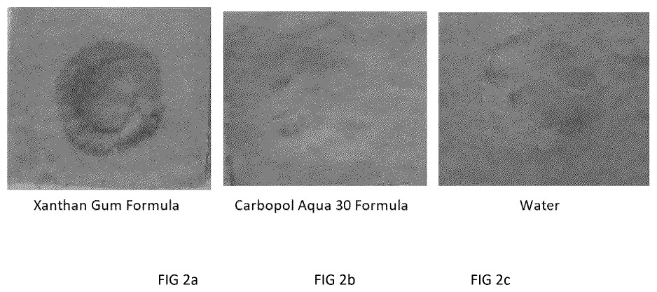

Testing was performed on 67.3 cm (26.5 inch) by 30.5 cm (12 inch) sheets of 709 g (25 oz) nylon, with a 5/32 gauge, 1.2 cm (0.470 inch) pile height, and 8 per inch stitch (approximately 3 per cm stitch). About 15 g of test sample was sprayed within each 16.5 cm (6.5 inch) length segment of the carpet (4 segments, 4 test samples). The carpet was allowed to air dry for 24 hours. The carpet was then placed on the inner diameter of tumbler barrel having a 21.4 cm (8.44 inch) diameter. The carpet was positioned so that the top portion (the pile) of the carpet faced the center of the tumbler barrel. A 30 g sample of carpet soil was placed inside the tumbler barrel along with 1.08 kg of 9.42 mm diameter chrome steel balls. The tumbler barrel was rotated in a circular fashion around its center axis at a rate of 360 degrees/second for 30 minutes. The barrel was then rotated in the opposition direction at a rate of 360 degrees/second for an additional 30 minutes. The carpet was removed from the tumbler barrel and examined. The results are provided in FIG. 2. As can be seen in FIG. 2, both water (FIG. 2c) and the formulation of Table 6 containing xanthan gum (FIG. 2a) clearly show a circular deposition of soil. In contrast, the disclosed composition (FIG. 2b) does not show any soil redeposition.

The foregoing description of various aspects of the invention has been presented for purposes of illustration and description. Embodiments and/or features therein may be freely combined with one another. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A cleaning composition comprising (a) approximately 0.5% w/w to approximately 5% w/w anionic surfactant; (b) approximately 0.05% w/w to approximately 15% w/w of a nonionic alcohol alkoxylate surfactant; (c) approximately 0.5% w/w to approximately 10% w/w of a copolymer having a monomer having the structure: 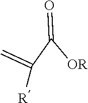
wherein R=an alkali metal, H, vinyl, a C1-C4 alkyl group, or combinations thereof, and R′=H, a C1-C4 alkyl group, or combinations thereof; (d) approximately 0.5% to approximately 15% w/w of a glycol ether; (e) approximately 0.5% w/w to approximately 10% w/w ethoxylated polyethylene imine; and (f) approximately 0.05% w/w to approximately 10% w/w of the composition of a water blend of (i) sodium carbonate, (ii) approximately 1% w/w to approximately 50% w/w of the water blend of monoterpene, (iii) approximately 1% w/w to approximately 50% w/w of the water blend of N,N′-dialkyl amides, and (iv) emulsifiers.

2. The cleaning composition of claim 1, wherein the anionic surfactant comprises an alkali alkyl sulfate, preferably an alkali C10-C14 sulfate.

3. The cleaning composition of claim 1, wherein the nonionic alcohol alkoxylate surfactant comprises a C4-C8 alcohol alkoxylate nonionic surfactant having 3-9 EO.

4. The cleaning composition according to claim 1, comprising approximately 1.5% w/w to approximately 2.5% w/w anionic surfactant comprising alkali C10-C14 sulfate anionic surfactant; (b) approximately 0.5% w/w to approximately 1.5% w/w of a C4-C8 alcohol alkoxylate nonionic surfactant having 3-9 EO; (c) approximately 3.0% to approximately 4.0% of a copolymer having a monomer having the structure: 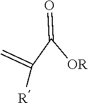
wherein R=an alkali metal, H, vinyl, a C1-C4 alkyl group, or combinations thereof, and R′=H, a C1-C4 alkyl group, or combinations thereof; (d) approximately 3.0% to approximately 6.0% w/w of a glycol ether; (e) approximately 1.5% w/w to approximately 2.5% w/w ethoxylated polyethylene imine; and (f) approximately 0.5% w/w to approximately 1.5% w/w of the composition of a water blend of (i) sodium carbonate, (ii) approximately 1% w/w to approximately 50% w/w of the blend of monoterpene, (iii) approximately 1% w/w to approximately 50% w/w of the blend of N,N′-dialkyl amides, and (iv) emulsifiers.

5. The cleaning composition of claim 1, wherein the copolymer comprises a monomer having the structure: 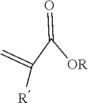
wherein (a) R and R′=H or (b) R=an alkali metal or H and R′=H or a C1-C4 alkyl group.

6. The cleaning composition of claim 5, wherein the copolymer comprises an acrylic copolymer emulsion, a water-based acrylic copolymer dispersion, a sodium acrylate copolymer, or combinations thereof.

7. The cleaning composition of claim 1, wherein the glycol ether comprises dipropylene glycol n-propyl ether, dipropylene glycol n-butyl ether, propylene glycol phenyl ether, or combinations thereof.

8. The cleaning composition of claim 1, further comprising a thickening agent, a sequestrant, a preservative, or any combination thereof.

9. The cleaning composition of claim 1, further comprising an additional nonionic surfactant selected from caprylyl/decyl glucoside, deceth-5, PPG-6-laureth-3, or combinations thereof.

10. The cleaning composition of claim 1, wherein the cleaning composition is substantially free of enzymes, hydrogen peroxide, hypohalites, percarboxylic acid, TAED, manganese salt catalyst, Cl₂, or combinations thereof.

11. The cleaning composition of claim 1, wherein the cleaning composition is substantially free of polysaccharide thickeners, such as xanthan gum.

12. A method of removing stains from soft surfaces, the method comprising applying the cleaning composition of claim 1 to the stain on the soft surface.

13. The method of claim 12, wherein the stain is an oxidizable stain and the soft surface is nylon, polyester, olefin, wool, or combinations thereof; preferably nylon, polyester, wool, or combinations thereof.

14. The method of claim 13, wherein the oxidizable stain is cola, grape juice, dirty motor oil, wine, tomato sauce, blood, tea, coffee, dressing, food grease, food oil, vegetable oil, oil based stain, grass stain, particulate stain, ink stain, or any combination thereof.

15. The method of claim 12, further comprising leaving the composition on the stain for approximately 1 second to approximately 10 minutes, preferably approximately 10 seconds to approximately 8 minutes, more preferably approximately 30 seconds to approximately 7 minutes, or most preferably approximately 1 minute to approximately 6 minutes.
